(19) United States
(12) Patent Application Publication
(10) Pub. No.: US 2008/0134967 A1
(43) Pub. Date: Jun. 12, 2008

(54) LIQUID EJECTION UNIT FOR PROBE ARRAY PRODUCTION APPARATUS AND METHOD OF MANUFACTURING THE SAME

(75) Inventors: Kenta Udagawa, Yokohama-shi (JP); Shuzo Iwanaga, Kawasaki-shi (JP); Toshiaki Hirosawa, Hiratsuka-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/950,014

(22) Filed: Dec. 4, 2007

(30) Foreign Application Priority Data
Dec. 8, 2006 (JP) 2006-332138

(51) Int. Cl. B05B 7/00; B29C 65/00

(52) U.S. Cl. 118/313; 156/60

(57) ABSTRACT

Liquid ejection chips 101, each having a ejection port 103, a supply port 104 communicating with the ejection port 103 by way of a flow channel 108 and a heater arranged in the flow channel 108, are bonded to a single chip plate 102 to form a two-dimensional array. As a result, a liquid ejection unit having a plurality of ejection ports 103 and a plurality of supply ports 104 is formed. As the heaters are driven while probe solutions are supplied to the respective supply ports 104, the probe solutions are ejected from the ejection ports 103 to the outside under the pressure of bubbles. The probe solutions of mutually different types are ejected respectively from the ejection ports 103 and made to adhere to a solid-phase substrate. Thus, a desired probe array can be manufactured.

### BACKGROUND OF THE INVENTION

1. Field of the Invention

The present invention relates to a liquid ejection unit for a probe array production apparatus and a method of manufacturing the same. The present invention also relates to a probe array production apparatus and a probe array production method.

2. Description of the Related Art

Techniques of using a plurality of DNA probes are known for analyzing the base sequence of DNA (deoxyribonucleic acid) as analyte and also for accurately examining DNA as analyte for a large number of items are known. More specifically, with these techniques, DNA probes are prepared by anchoring a plurality of nucleic acids having respective base sequences that are different from each other to a solid-phase substrate and an analyte DNA solution is injected and brought into contact with the DNA probes. Labeled nucleic acids carrying a labeling substance such as a fluorescent substance are employed and a hybridization reaction is caused to take place between the DNA of the analyte and part of the DNA probes to see the type of the DNA probe that worked with the DNA of the analyte for hybridization by detecting the labeling substance caught by the DNA probe. The DNA of the analyte is analyzed in this way. Probe arrays (DNA micro chips) that are formed by compactly arranging a large number of DNA probes of mutually different types in a two-dimensional array are being used for the purpose of analyzing the DNAs of analytes.

Various methods are known to date for anchoring a large number of DNA probes of mutually different types onto a solid-phase substrate in an array. Such conventional methods include those of synthesizing and purifying DNAs for probes, determining the base lengths thereof if necessary and supplying the DNAs onto a substrate by means of a device such as a micro dispenser to produce a probe array. Japanese Patent Application Laid-Open No. H11-187900 discloses a method of ejecting probe solutions (liquids containing DNAs for probes) and causing them to adhere to a solid-phase substrate as liquid drops by means of a thermal liquid ejection unit to produce spot-like probes on the solid-phase substrate. However, the disclosed method is adapted to use an ordinary printer head as liquid ejection unit, which is not structurally optimal for producing a probe array by any means.

On the other hand, there has been proposed a method adapted to use a liquid ejection unit including a liquid ejection chip where ejection ports are arranged in the form of a two-dimensional array and a liquid supply plate where supply sections are arranged also in the form of a two-dimensional array vis-à-vis the respective ejection ports. Japanese Patent Application Laid-Open No. 2002-281968 discloses an arrangement for supplying liquid to a single ejection port from a single liquid container so that a probe solution can be supplied with such a simple arrangement.

With any of the above-described arrangements, a liquid ejection chip having a plurality of ejection ports and a plurality of supply ports and mounted on a liquid ejection unit can be prepared in a manner as described below. Electric wiring and a circuit are formed on a Si single crystal wafer, an orifice plate is laid thereon to form ejection ports, and the wafer is provided with supply ports that run through the wafer. Normally, a large number of structures, each including a plurality of ejection ports and a plurality of supply ports, are densely arranged on a single wafer. Such structures are collectively produced on a single wafer by way of a process similar to a semiconductor manufacturing process. Then, the wafer is cut into structures, each having a predetermined number of ejection ports and also a predetermined number of supply ports to produce individual liquid ejection chips. It is desirable to reduce the area of each liquid ejection chip on the wafer because the cost of each liquid ejection chip can be reduced by increasing the number of liquid ejection chips produced from a single wafer.

With the above-described manufacturing process, a desired level of positional precision of the ejection ports can be secured with ease because all the ejection ports are collectively prepared. Additionally, the above-described manufacturing process is characterized by a high degree of freedom for arranging ejection ports.

FIG. 6 is a schematic perspective view illustrating part of a conventional liquid ejection unit. The liquid ejection chip 401 of the liquid ejection unit is provided at the rear surface side thereof with supply ports (not illustrated) for supplying probe solutions and at the front surface side thereof with ejection ports 401a for ejecting the supplied probe solutions. Additionally, the liquid ejection chip 401 contains therein a heater (not illustrated) for applying ejection energy. The chip plate 402 on which the liquid ejection chip 401 is laid is adapted to absorb the thermal expansion difference that arises when the liquid ejection chip 401 is bonded to some other part (e.g., the cabinet 403 of the liquid ejection unit). Liquid is supplied to the liquid ejection chip 401 by way of the cabinet 403 and the chip plate 402 and a liquid ejection signal is transmitted also to the liquid ejection chip 401. The structure of the liquid ejection unit can be simplified when the gaps separating the ejection ports 401a of the liquid ejection unit is made equal to the gaps separating the supply ports.

Sometimes, the gaps separating the ejection ports 401a of a liquid ejection unit having the above-described configuration are desired to be large depending on the liquid supply structure. However, as the gaps separating the ejection ports 401a is made large, the void (unused region) on the wafer increases to lower the efficiency of the use of the wafer and raise the cost. FIG. 7 is a schematic illustration a process of producing a plurality of liquid ejection chips 401 employed in a conventional liquid ejection unit from a single wafer 405. When each liquid ejection chip 401 takes a large area, the number of liquid ejection chips 401 that can be produced from a single wafer 405 is reduced to by turn enlarge the unused region 406 on the wafer 405.

The above-described liquid ejection unit has a large number of ejection ports 401a and a large number of heaters in the single liquid ejection chip 401 thereof and, if one of the large number of ejection ports 401a and the large number of heaters turns out to be defective, the entire liquid ejection chip is taken for a defective product to reduce the manufacturing yield.

When the diameter of each of the supply ports is increased in order to raise the efficiency of supplying liquid, the gaps separating the ejection ports 401a is also increased to by turn increase the dimensions of the liquid ejection chip 401. Additionally, when the number of probes is raised in order to increase the number of objects of examination and improve the accuracy of examination of a probe array, the liquid ejection unit for manufacturing the probe array is required to have an increased number of ejection ports 401a. Then, as a matter of course, the liquid ejection chip 401 becomes larger as the number of ejection ports 401a is increased. As the liquid ejection chip 401 becomes larger, the number of liquid ejection chips 401 that can be produced from a single wafer 405 may have to be decreased to raise the manufacturing cost per liquid ejection chip or the size of the wafer 405 may have to be increased to end up in requiring a new semiconductor manufacturing apparatus that corresponds to the increased size of the wafer 405. Since the size of the liquid ejection chip 401 is limited by the size of the wafer 405, it is not possible to manufacture a liquid ejection chip larger than the currently available largest wafer as a matter of course cannot be manufactured.

### SUMMARY OF THE INVENTION

In view of the above-identified circumstances, the present invention provides a liquid ejection unit for a probe array production apparatus and a method of manufacturing the same that can relatively freely arrange ejection ports if the gaps separating the ejection ports are large, and manufacture a desired probe array without raising the manufacturing cost along with a probe array production apparatus and a probe array production method.

A liquid ejection unit for a probe array production apparatus for arranging a plurality of probes of mutually different types in a two-dimensional array on a substrate according to the present invention is characterized in that a plurality of liquid ejection chips having supply ports for receiving probe solutions supplied thereto to form respective probes and ejection ports for ejecting the probe solutions are arranged in array on a common support.

Thus, according to the present invention, a liquid ejection chip having ejection ports for ejecting probe solutions and supply ports can be made to occupy a minimal necessary area to enable to manufacture a large number of liquid ejection chips from a single wafer. Additionally, probe arrays of various different profiles can be manufactured with ease by appropriately changing the arrangement of such small liquid ejection chips. Still additionally, when a problem such as one or more clogged ejection ports arises, only the defective liquid ejection chip or chips out of the plurality of liquid ejection chips can be eliminated and replaced so that the yield of manufacturing liquid ejection units can be raised.

Further features of the present invention will become apparent from the following description of exemplary embodiments with reference to the attached drawings.

### BRIEF DESCRIPTION OF THE DRAWINGS

FIG. 1A is a schematic perspective view of a liquid ejection unit according to the first embodiment of the present invention and FIG. 1B is an enlarged schematic perspective view of one of the liquid ejection chips thereof.

FIG. 2 is a schematic perspective view of a probe array formed by means of the liquid ejection unit of FIG. 1A.

FIG. 3 is a schematic illustration of the layout of liquid ejection chips as illustrated in FIG. 1B on a single wafer.

FIG. 4A is a schematic perspective view of a liquid ejection unit according to the second embodiment of the present invention and FIG. 4B is an enlarged schematic perspective view of one of the liquid ejection chips thereof.

FIG. 5 is a schematic perspective view of a liquid ejection unit according to the third embodiment of the present invention.

FIG. 6 is a schematic perspective view of a conventional liquid ejection unit.

FIG. 7 is a schematic illustration of the layout of conventional liquid ejection chips for a liquid ejection unit as illustrated in FIG. 6 on a single wafer.

### DESCRIPTION OF THE EMBODIMENTS

Now, the present invention will be described in greater detail by referring to the accompanying drawings that illustrate preferred embodiments of the invention.

For the purpose of the present invention, a probe refers to a substance that can be specifically bonded to a target substance. Probes typically include nucleic acid probes for capturing a target nucleic acid and ligands for capturing a target protein.

A probe array refers to a plurality of probes of mutually different types arranged in the form of a two-dimensional array on a substrate. Generally, a large number of probes (nucleic acid probes) are anchored onto a substrate typically by covalent bonding as in the case of a DNA micro-array.

### First Embodiment

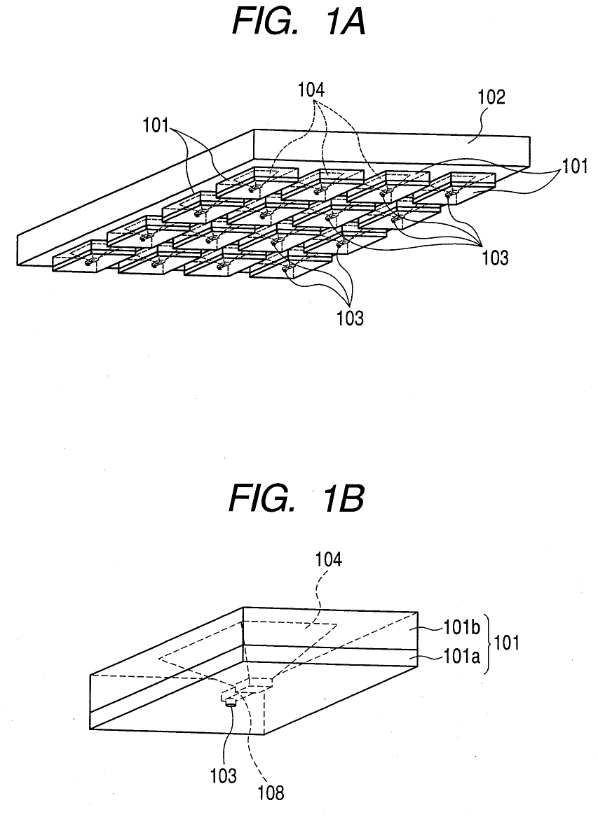

FIG. 1A is a schematic perspective view of liquid ejection unit according to the first embodiment of the present invention, illustrating principal parts thereof. The liquid ejection unit is formed by bonding a plurality of liquid ejection chips 101 to a single chip plate 102. FIG. 1B is an enlarged schematic perspective view of one of the liquid ejection chips 101. Each of the liquid ejection chips 101 is by turn formed by laying an orifice plate 101a on a Si single crystal substrate 101b. The liquid ejection chip 101 is provided at the front surface side thereof with an ejection port 103 for ejecting liquid and at the rear surface side thereof with a supply port 104 for supplying liquid. The ejection port 103 and the supply port 104 communicate with each other by way of a flow channel 108. Although not illustrated, a heater (heat emitting element) that is an energy-generating element is arranged in the inside of the flow channel 108 to apply ejection energy to liquid. The chip plate 102 has holes (not illustrated) for supplying liquid to the supply port 104 of each of the liquid ejection chips 101. The flow path part for leading liquid from the supply port 104 to the flow channel 108 in each of the liquid ejection chips 101 takes a role of reservoir for holding probe solution and is formed to show a profile of an inverted pyramid typically by anisotropic etching as illustrated in FIG. 1B.

In this embodiment, the liquid ejection chips 101 are arranged in the form of a 4×4 two-dimensional array and bonded to the single chip plate 102 by flip-chip bonding. Thus, the liquid ejection unit of this embodiment has sixteen ejection ports 103 and sixteen supply ports 104.

A heater is arranged in each of the liquid ejection chips 101 at a position located vis-à-vis the ejection port 103 thereof. Although not illustrated, the wiring pattern connected to the heater extends to the rear surface through the hole running through the liquid ejection chip 101 so as to be connected to a connection bump (electric connection section). Pads are arranged on the chip plate 102 so as to be held in contact with the respective bumps and connected to the wiring patterns printed on the front surface of the chip plate 102. Thus, the signal input from the outside transmitted from the wiring patterns printed on the front surface of the chip plate 102 to the wiring patterns of the liquid ejection chips 101 by way of the pads and the bumps and then further to the heaters. As the signal from the outside is transmitted to the heaters to heat the heaters while liquid (probe solution) that contains DNA for probes is supplied from the supply ports, the probe solution bubbles. Thus, the probe solution from the ejection ports 103 to the outside can be ejected under the pressure of the bubbles.

As DNA for probes are made to adhere to the surface of a solid-phase substrate, which may be a glass substrate, by means of this liquid ejection unit, a large number of (sixteen in the case of this embodiment) DNA probes 105 are formed substantially at the same time. Thus, a probe array (DNA micro chip) 106 as illustrated in FIG. 2 can be manufactured with ease. Particularly, a large number of DNA probes 105 of mutually different types on a single probe array 106 can be formed with ease by supplying solutions containing different DNAs respectively to the supply ports 104 of the liquid ejection chips 101.

When it is desired to manufacture a probe array 106 having a greater number of DNA probes 105, it is only necessary to increase the number of liquid ejection chips 101 that are to be bonded to a chip plate 102. When, to the contrary, it is desired to manufacture a probe array 106 having a smaller number of DNA probes 105, it is only necessary to decrease the number of liquid ejection chips 101 that are to be bonded to a chip plate 102. With this embodiment, the number of ejection ports 103 for forming DNA probes 105 can be increased or decreased by one at smallest so that any desired number of DNA probes 105 can be manufactured with ease.

Additionally, with this embodiment, whether any liquid ejection chip 101 that is electrically defective or has an ejection port illustrating a defective profile can be found out and these defects can be eliminated. Therefore, any assembled liquid ejection unit can be prevented from including any defective liquid ejection chip 101. In other words, the manufacturing yield of liquid ejection chips 101 is not directly reflected to the manufacturing yield of liquid ejection units. Still additionally, while a conventional liquid ejection unit is entirely defective when one of its ejection ports or heaters is found defective, this embodiment is entirely free from such a problem because it is only necessary to replace a liquid ejection chip 101 that is found as defective out of the large number of liquid ejection chips 101.

Now, the method of manufacturing the liquid ejection chips 101 of the liquid ejection unit of this embodiment will be described below.

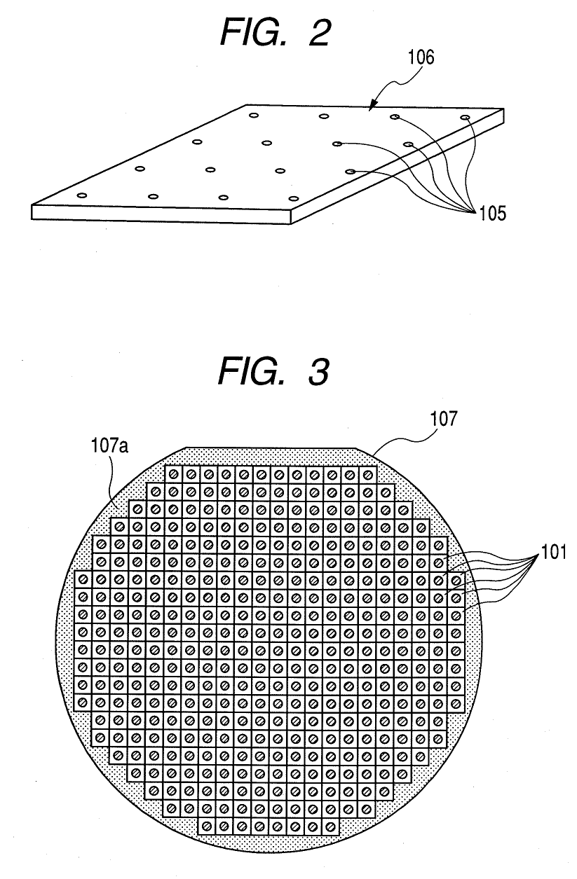

FIG. 3 schematically illustrates the method of producing a large number of liquid ejection chips 101 from a Si single crystal wafer 107. Since each of the liquid ejection chips 101 of this embodiment has only a small area, the liquid ejection chips 101 on a single wafer 107 can be laid out considerably freely. Then, a large number of individual liquid ejection chips 101 can be produced by cutting the wafer 107 and separating the liquid ejection chips 101 from each other. Thus, the unused region 107a of the wafer 107 can be minimized to reduce the manufacturing cost of each liquid ejection chip 101. The size of the liquid ejection chips 101 is not significantly affected by the arrangement of the ejection ports 103 in the liquid ejection unit.

As an example, let us consider a case of producing liquid ejection chips arranged in a two-dimensional array of 32 rows ×32 columns on a substantially circular wafer 107 having a diameter of 6 inches (about 152 mm) with their ejection ports arranged at a pitch of 2.88 mm. Conventionally, only a single liquid ejection chip can be produced from a single wafer 107. On the other hand, 1,716 liquid ejection chips 101, each having a size of 2.88 mm ×2.88 mm with a single ejection port 103 are laid out and obtained, on a single wafer 107 with the above-described embodiment. While 32×32=1,024 ejection ports are conventionally produced from a single wafer 107, 1,716 ejection ports are produced from a single wafer 107 with the above-described embodiment. In other words, this embodiment provides an efficiency of use of a wafer of about 1.7 times if compared with the conventional one. While the size of each liquid ejection chip 101 includes the cutting margin for dicing, the efficiency of use of a wafer 107 can be further raised by reducing the size of each liquid ejection chip 101. For example, if the size is reduced to 2.50 mm ×2.50 mm for a liquid ejection chip 101, about 2,300 liquid ejection chips 101 can be obtained from a single wafer 107.

The plurality of liquid ejection chips 101 obtained in the above-described manner are then arranged in a two-dimensionally array on the surface of a single chip plate 102 and bonded to the latter, while wiring patterns (not illustrated) (or bonding wires) are used to electrically connect them to respective heaters. A liquid ejection unit as illustrated in FIG. 1A can be manufactured in the above-described way.

A probe array production apparatus is formed by fitting the liquid ejection unit to a holding device (not illustrated). Then, mutually different probe solutions can be supplied to the respective supply ports 104 of the probe array production apparatus, drive the heaters and eject the probe solutions from the respective ejection ports 103 onto a solid-phase substrate so as to make them adhere to the substrate. In this way, a desired probe array can be manufactured.

The probe array manufacturing method is described in greater detail in U.S. No. 2002-0182610 Official Gazette, which can be referred to for the purpose of the present invention.

An ejection port 103 and a supply port 104 show a one to one correspondence in each liquid ejection chip 101 of this embodiment. However, when a plurality of similar ejection ports 103 are provided for a single supply port 104 and if the currently operating ejection port 103 is clogged by a foreign object, it may be replaced by some other ejection port 103 to smoothly eject liquid. In shorts, the ejection ports other than the currently operating one can be used as reserves.

### Second Embodiment

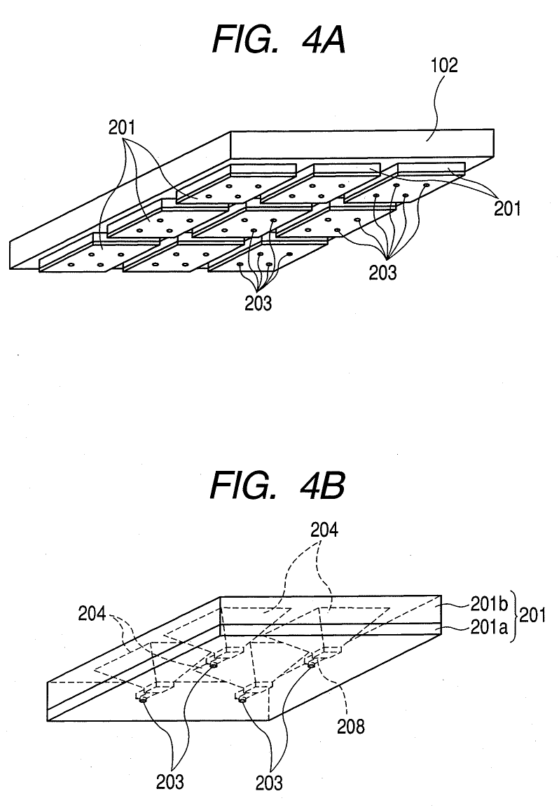

FIG. 4A is a schematic perspective view of liquid ejection unit according to the second embodiment of the present invention, illustrating a principal part thereof. FIG. 4B is an enlarged schematic perspective view of one of the liquid ejection chips 201 thereof. Each of the liquid ejection chips 201 of this embodiment is formed by laying an orifice plate 201a on a Si single crystal substrate 201b. The liquid ejection chip 201 is provided at the front surface side thereof with four ejection ports 203 and at the rear surface side thereof with four supply ports 204 to show a one to one correspondence. Each of the ejection ports 203 and the corresponding one of the supply ports 204 communicate with each other by way of a flow channel 208. A heater is arranged in the inside of each of the flow channels 208. Liquid ejection chips 201, each having four ejection ports 203 and four supply ports 204, are arranged in the form of a 3×3 two-dimensional array and bonded to a single chip plate 102 by flip-chip bonding. Thus, the liquid ejection unit of this embodiment has 36 ejection ports 203 and 36 supply ports 204.

It may be safe to say that the liquid ejection unit of this embodiment is somewhere between the conventional liquid ejection unit illustrated in FIG. 6 and the liquid ejection unit of the first embodiment illustrated in FIG. 1A. More specifically, the arrangement of the first embodiment where a large number of liquid ejection chips 101, each having a single ejection port 103 and a single supply port 104, are used may require a very cumbersome assembling process. On the other hand, the assembling process of this embodiment can be simplified if compared with the first embodiment because liquid ejection chips 201, each having a small number (e.g., four) of ejection ports 203 and a small number (e.g., four) of supply ports 204, are used. Additionally, if compared with the conventional arrangement, each liquid ejection chip 201 is downsized to enable to improve the efficiency of use of a wafer and eliminate and replace a defective chip with ease for the purpose of reducing wastes.

When such a liquid ejection chip 201 is used, for example, four types of bases including adenine, guanine, cytosine and thymine (A, T, C, G) may be supplied respectively to the four supply ports 204 of the single liquid ejection chip 201. Then, DNA can be synthesized by way of a sequential elongation reaction of the ejected bases as the latter are ejected from the respective ejection ports 203. It may be so arranged that the four bases are supplied respectively to the supply ports 204 of each of all the liquid ejection chips 201.

It should be noted that the number of supply ports 204 and that of ejection ports 203 arranged in each liquid ejection chip 201 are by no means limited to four. In other words, if necessary, a liquid ejection unit where each liquid ejection chip 201 has an arbitrarily selected number of supply ports 204 and an arbitrarily selected number of ejection ports 203 can be designed.

All the remaining parts of the configuration and those of the manufacturing method of this embodiment are similar to those of the first embodiment and hence will not be described here any further.

### Third Embodiment

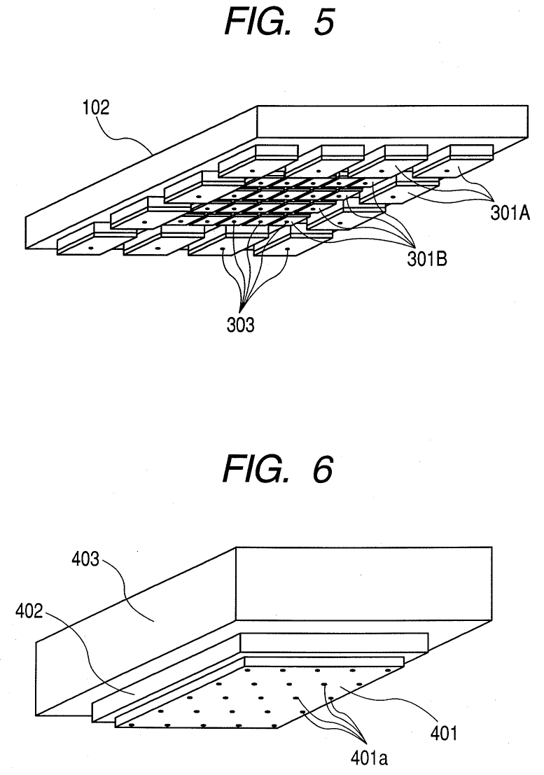

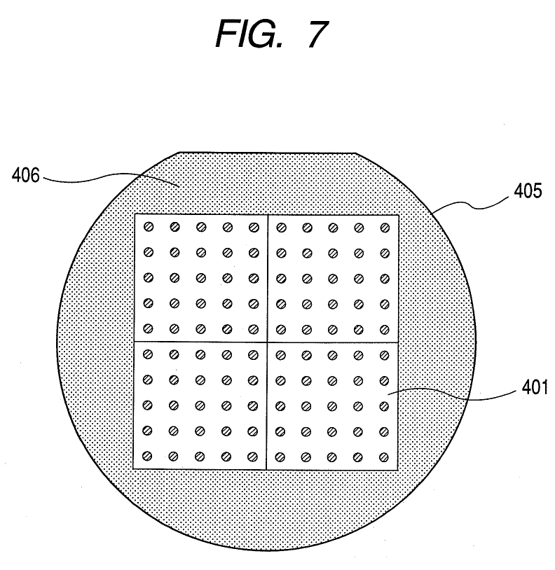

FIG. 5 is a schematic perspective view of liquid ejection unit according to the third embodiment of the present invention, illustrating a principal part thereof. The liquid ejection chips of this embodiment include large liquid ejection chips 301A and small liquid ejection chips 301B. While both the liquid ejection chips 301A and the liquid ejection chips 301B have a single ejection port 303 and a single supply port (not illustrated), the rate of ejecting liquid drops is differentiated between the large liquid ejection chips 301A and the small liquid ejection chips 301B. Although not illustrated, the size of the supply port of liquid ejection chip is also differentiated between the large liquid ejection chips 301A and the small liquid ejection chips 301B so as to make it match the liquid consumption rate because of the difference in the rate of ejecting liquid drops.

In this embodiment, four large liquid ejection chips 301A showing a high rate of ejecting liquid drops are arranged along each of the four outer peripheral sides of the a chip plate 102 to define a rectangle in the inside thereof. Then, small liquid ejection chips 301B showing a low rate of ejecting liquid drops are arranged in the form of a 5×4 two-dimensional array in the inside of the rectangle defined by the large liquid ejection chips 301A.

With conventional liquid ejection units, it is difficult to change the height from ejection port to ejection port because all the ejection ports are integrally formed. To the contrary, with this embodiment, liquid ejection chips showing a high rate of ejecting liquid drops and liquid ejection chips showing a low rate of ejecting liquid drops are prepared separately and combined subsequently so that a mixture of ejection ports 303 illustrating a high rate of ejecting liquid drops and ejection ports 303 illustrating a low rate of ejecting liquid drops can be provided in a single liquid ejection unit. Furthermore, ejection ports 303 showing a high rate of ejecting liquid drops and ejection ports 303 showing a low rate of ejecting liquid drops can be arranged relatively freely.

For example, there are occasions where position reading/detection marks are formed along the outer periphery of a probe array by ejecting liquid drops just like a probe solution. Large such marks need to be formed by means of large liquid drops so that the marks may be read reliably. This embodiment can particularly advantageously be used in such occasions. Additionally, there are occasions where liquid drops need to be ejected at a high rate because a lowly reactive probe solution is used to form DNA probes. This embodiment can particularly advantageously be used also in such occasions. Since liquid ejection chips showing different rates of ejecting liquid drops can be arranged appropriately with this embodiment, a liquid ejection unit that precisely matches the application can be manufactured with ease.

All the remaining parts of the configuration and those of the manufacturing method of this embodiment are similar to those of the first and second embodiments and hence will not be described here any further.

The present invention is not limited to the above-mentioned embodiments and various changes and modifications can be made within the spirit and scope of the present invention. Therefore, to apprise the public of the scope of the present invention, the following claims are made.

This application claims the benefit of Japanese Patent Application No. 2006-332138, filed Dec. 8, 2006, which is hereby incorporated by reference in its entirety.

What is claimed is:

1. A liquid ejection unit for a probe array production apparatus for manufacturing a plurality of probes of mutually different types in a two-dimensional array on a substrate comprising:
a plurality of liquid ejection chips having supply ports for receiving probe solutions supplied thereto to form respective probes and ejection ports for ejecting the probe solutions are arranged in array on a common support.

2. The liquid ejection unit according to claim 1, wherein
each of the liquid ejection chips has a single ejection port and a single supply port.

3. The liquid ejection unit according to claim 1, wherein
each of the liquid ejection chips has a plurality of ejection ports and supply ports as many as the ejection ports, and the ejection ports respectively communicate with the supply ports by way of mutually independent respective flow channels.

4. The liquid ejection unit according to claim 1, wherein
each of the liquid ejection chips has at least a supply port and ejection ports whose number is greater than that of the supply port, and part of the plurality of ejection ports is a reserve or reserves.

5. The liquid ejection unit according to claim 1, wherein
the plurality of liquid ejection chips include liquid ejection chips showing a high rate of ejecting liquid drops and liquid ejection chips showing a low rate of ejecting liquid drops.

6. The liquid ejection unit according to claim 1, wherein
each of the liquid ejection chips has an energy-generating element for applying ejection energy to the probe solution.

7. The liquid ejection unit according to claim 6, wherein
each of the liquid ejection chips has an electric connection section arranged at the surface opposite to the surface where the ejection port is formed, and a wiring pattern for connecting the energy-generating element and the electric connection section.

8. A probe array production apparatus comprising a liquid ejection unit according to claim 1.

9. A method of manufacturing a liquid ejection unit to be used in a probe array production apparatus for manufacturing a probe array having a plurality of mutually different probes arranged in the form of a two-dimensional array on a substrate, the method comprising:
a step of forming a plurality of liquid ejection chips having supply ports for receiving probe solutions supplied thereto to form respective probes and ejection ports for ejecting the probe solutions; and
a step of arranging the plurality of liquid ejection chips on a common support and bonding them to the common support.

10. A probe array manufacturing method for anchoring a plurality of probes of mutually different types onto a solid-phase substrate in the form of an array, the method comprising:
holding the solid-phase substrate to a position of a probe array production apparatus according to claim 8 located vis-à-vis the ejection ports of the liquid ejection unit and ejecting the probe solutions from the liquid ejection chips onto the solid-phase substrate so as to cause them to adhere to the solid-phase substrate.

11. The probe array manufacturing method according to claim 10, wherein
probe solutions of mutually different types are supplied to the supply ports of the plurality of liquid ejection chips.

12. The probe array manufacturing method according to claim 10, wherein
each of the liquid ejection chips is provided with a plurality of ejection ports and a plurality of supply ports and the probe solutions of mutually different types are supplied respectively to the plurality of supply ports so that the combination of the probe solutions of different types supplied respectively to the plurality of supply ports are reproduced on each of the liquid ejection chips.
